(19) United States
(12) Patent Application Publication
(10) Pub. No.: US 2024/0017974 A1
(43) Pub. Date: Jan. 18, 2024

(54) VEHICLE FUEL UNIT LIFT

(71) Applicant: Vehicle Service Group, LLC, Madison, IN (US)

(72) Inventors: Jason Stewart, Harvest, AL (US); Ron Schneider, Addyston, OH (US)

(73) Assignee: Vehicle Service Group, LLC, Madison, IN (US)

(21) Appl. No.: 18/220,870

(22) Filed: Jul. 12, 2023

Related U.S. Application Data
(60) Provisional application No. 63/388,797, filed on Jul. 13, 2022.

(51) Int. Cl. B66F 3/46

(52) U.S. Cl. CPC B66F 3/46; B60S 5/06

(57) ABSTRACT

A fuel unit assembly-lifting adapter is configured to couple with a vehicle lift in order to engage, raise, and lower a fuel unit assembly. The fuel unit assembly-lifting adapter includes an elongated fuel unit assembly-engaging portion terminating into a first end and a second end and a lift-engaging portion comprising a first member extending from the first end of the fuel unit assembly-engaging portion, and a second member extending from the second end of the fuel unit assembly-engaging portion, wherein the first member and the second member are configured to detachably engage a vehicle lift such that the fuel unit assembly-engaging portion may raise and lower the fuel unit assembly in response to movement of the vehicle lift.

This application claims priority to U.S. Provisional Application Ser. No. 63/388,797, entitled Vehicle Fuel Unit Pallet Lift, filed on Jul. 13, 2022, the disclosure of which is incorporated by reference herein.

### BACKGROUND

A vehicle lift is a device operable to lift a vehicle such as a car, truck, bus, etc. Vehicle lifts have varying designs and capabilities, including platform lifts that lift a parked vehicle via contact with tires in order to allow access to the underside of the vehicle, while frame-engaging lifts raise a vehicle by contacting structural lifting points on the frame of the vehicle, allowing access to the underside of the vehicle and allowing wheels and tires to be removed or serviced.

Frame-engaging vehicle lifts may include adjustable arms configured to adjust into various positions to suitably engage the frame of a vehicle. In some instances, an adjustable arm may be able to adjust its own length to suitably engage the frame of a vehicle. Additionally or alternatively, an adjustable arm may be configured to pivot relative to other portions of the vehicle lift to suitably engage the frame of a vehicle.

In some instances, it may be desirable to replace an electric vehicle (“EV”) battery or a fuel cell (generically referred to herein as a “fuel unit”) in a vehicle powered by such sources. In such instances, the previously used fuel unit may be removed from the vehicle and the replacement fuel unit may be installed. Once the previously used fuel unit is suitably removed, it may be desirable to position the replacement fuel unit on a lift table in order to position the replacement fuel unit adjacent to the corresponding portions of the vehicle intended to receive and mount the replacement fuel unit. In some instances, a forklift is used to engage and lift a fuel unit pallet supporting the fuel unit, and then position that fuel unit pallet onto a support surface of the lift table in order to suitably mount the replacement fuel unit. For purposes of this disclosure and the claims, a “fuel unit assembly” may consist essentially of a fuel unit, or it may comprise a fuel unit on a supporting structure, whether or not the fuel unit is mechanically attached to the supporting structure.

While a variety of vehicle lifts and associated adapters have been made and used, it is believed that no one prior to the inventor(s) has made or used an invention as described herein.

### BRIEF DESCRIPTION OF THE DRAWINGS

While the specification may conclude with claims that particularly point out and distinctly claim the invention, it is believed the present invention will be better understood from the following description of certain examples taken in conjunction with the accompanying drawings, in which like reference numerals identify the same elements and in which:

FIG. 1 is a perspective view of an example of a fuel unit pallet-lifting adapter that may be used in conjunction with a vehicle lift;

FIG. 2 is a perspective view of a second example of a fuel unit pallet-lifting adapter that may be used in conjunction with a vehicle lift;

FIG. 3A is a perspective view of an example of a two-post lift assembly in a lowered configuration, a fuel unit pallet resting on the ground supporting an EV battery, and a pair of fuel unit pallet-lifting adapters of FIG. 1, where the fuel unit pallet-lifting adapters are disengaged from both the fuel unit pallet and the two-post lift assembly;

FIG. 3B is a perspective view of the two-post lift assembly of FIG. 3A, the fuel unit pallet and EV battery of FIG. 3A, and the pair of fuel unit pallet-lifting adapters of FIG. 1, where the two-post lift assembly is in the lowered configuration, where the fuel unit pallet-lifting adapters are inserted through the pathways defined by the fuel unit pallet and disengaged from the two-post lift assembly, where the fuel unit pallet is resting on the ground and supporting the EV battery;

FIG. 3C is a perspective view of the two-post lift assembly of FIG. 3A, the fuel unit pallet and EV battery of FIG. 3A, and the pair of fuel unit pallet-lifting adapters of FIG. 1 inserted through the pathway defined by the fuel unit pallet, where the two-post lift assembly is in the lowered configuration, where the fuel unit pallet-lifting adapters are aligned with, yet disengaged from the two-post lift assembly, and where the fuel unit pallet is resting on the ground and supporting the EV battery;

FIG. 3D is a perspective view of the two-post lift assembly of FIG. 3A, the fuel unit pallet and EV battery of FIG. 3A, and the pair of fuel unit pallet-lifting adapters of FIG. 1 inserted through the pathway defined by the fuel unit pallet, where the two-post lift assembly is elevated from the lowered configuration to engage the fuel unit pallet-lifting adapters, where the fuel unit pallet is resting on the ground and supporting the EV battery;

FIG. 3E is a perspective view of the two-post lift assembly of FIG. 3A, the fuel unit pallet and EV battery of FIG. 3A, and the pair of fuel unit pallet-lifting adapters of FIG. 1 inserted through the pathway defined by the fuel unit pallet, where the two-post lift assembly is further elevated from the lowered configuration such that the fuel unit pallet is elevated from the ground while supporting the EV battery;

FIG. 3F is a perspective view of the two-post lift assembly of FIG. 3A, the fuel unit pallet and EV battery of FIG. 3A, and the pair of fuel unit pallet-lifting adapters of FIG. 1 inserted through the pathway defined by the fuel unit pallet, where the two-post lift assembly and the pair of fuel unit pallet-lifting adapters are supporting the elevated fuel unit pallet and the EV battery, and where a lift table is moved directly under the elevated fuel unit pallet and the EV battery;

FIG. 3G is a perspective view of the two-post lift assembly of FIG. 3A, the fuel unit pallet and EV battery of FIG. 3A, and the pair of fuel unit pallet-lifting adapters of FIG. 1 inserted through the pathway defined by the fuel unit pallet, where the two-post lift assembly is in the lowered configuration such that the elevated fuel unit pallet and the EV battery are supported by the lift table of FIG. 3F;

FIG. 4A is a perspective view of a two-post lift assembly in a first elevated configuration, a fuel unit pallet resting on the ground supporting an EV battery, and a pair of fuel unit pallet-lifting adapters of FIG. 2, where the fuel unit pallet-lifting adapters are disengaged from both the fuel unit pallet and the two-post lift assembly;

FIG. 4B is a perspective view of the two-post lift assembly of FIG. 4A, the fuel unit pallet and EV battery of FIG. 4A, and the pair of fuel unit pallet-lifting adapters of FIG. 2, where the two-post lift assembly is in the first elevated configuration, where the fuel unit pallet-lifting adapters are inserted through the pathways defined by the fuel unit pallet and disengaged from the two-post lift assembly, and where the fuel unit pallet is resting on the ground and supporting the EV battery;

FIG. 4C is a perspective view of the two-post lift assembly of FIG. 4A, the fuel unit pallet and EV battery of FIG. 4A, and the pair of fuel unit pallet-lifting adapters of FIG. 2 inserted through the pathway defined by the fuel unit pallet, where the two-post lift assembly is in the first elevated configuration and engaged with the fuel unit pallet-lifting adapters, where the fuel unit pallet is resting on the ground and supporting the EV battery;

FIG. 4D is a perspective view of the two-post lift assembly of FIG. 4A, the fuel unit pallet and EV battery of FIG. 4A, and the pair of fuel unit pallet-lifting adapters of FIG. 2 inserted through the pathway defined by the fuel unit pallet, where the two-post lift assembly is further elevated from the lowered configuration such that the fuel unit pallet is elevated from the ground while supporting the EV battery;

FIG. 4E is a perspective view of the two-post lift assembly of FIG. 4A, the fuel unit pallet and EV battery of FIG. 4A, and the pair of fuel unit pallet-lifting adapters of FIG. 2 inserted through the pathway defined by the fuel unit pallet, where the two-post lift assembly and the pair of fuel unit pallet-lifting adapters are supporting the elevated fuel unit pallet and the EV battery, where a lift table is moved directly under the elevated fuel unit pallet and the EV battery;

FIG. 4F is a perspective view of the two-post lift assembly of FIG. 4A, the fuel unit pallet and EV battery of FIG. 4A, and the pair of fuel unit pallet-lifting adapters of FIG. 2 inserted through the pathway defined by the fuel unit pallet, where the two-post lift assembly and the pair of fuel unit pallet-lifting adapters are supporting the elevated fuel unit pallet and the EV battery, and where a lift table is moved directly under the elevated fuel unit pallet and the EV battery;

FIG. 4G is a perspective view of the two-post lift assembly of FIG. 4A, the fuel unit pallet and EV battery of FIG. 4A, and the pair of fuel unit pallet-lifting adapters of FIG. 2 inserted through the pathway defined by the fuel unit pallet, where the two-post lift assembly is such that the elevated fuel unit pallet and the EV battery are supported by the lift table of FIG. 4E;

FIG. 5 is a perspective view of the of the two-post lift assembly of FIG. 3A, a pair of alternative fuel unit pallet-lifting adapters, a fuel unit pallet, and an EV fuel unit resting on the fuel unit pallet, where the fuel unit pallet-lifting adapters are engaged with the two-post lift assembly and the fuel unit pallet while the fuel unit pallet is resting on the ground and supporting the EV battery;

FIG. 6 is a perspective view of a third example of a fuel unit pallet-lifting adapter that may be used in conjunction with a vehicle lift;

FIG. 7A is a perspective view of a two-post lift assembly in a first elevated configuration, a fuel unit pallet resting on the ground supporting an EV battery, and a pair of fuel unit lifting adapters of FIG. 6, where the fuel unit lifting adapters are disengaged from both the fuel unit pallet, the EV battery, and the two-post lift assembly;

FIG. 7B is a perspective view of the two-post lift assembly of FIG. 7A, the fuel unit pallet and EV battery of FIG. 7A, and the pair of fuel unit lifting adapters of FIG. 6, where the two-post lift assembly is in the first elevated configuration, where the fuel unit lifting adapters are inserted through the pathways defined between the EV battery and the fuel unit pallet and disengaged from the two-post lift assembly, and where the fuel unit pallet is resting on the ground and supporting the EV battery;

FIG. 7C is a perspective view of the two-post lift assembly of FIG. 7A, the fuel unit pallet and EV battery of FIG. 7A, and the pair of fuel unit lifting adapters of FIG. 6 inserted through the pathway defined by the EV battery and the fuel unit pallet, where the two-post lift assembly is in the first elevated configuration and engaged with the fuel unit lifting adapters, where the fuel unit pallet is resting on the ground and supporting the EV battery;

FIG. 7D is a perspective view of the two-post lift assembly of FIG. 7A, the fuel unit pallet and EV battery of FIG. 7A, and the pair of fuel unit lifting adapters of FIG. 6 inserted through the pathway defined by the EV battery and the fuel unit pallet, where the two-post lift assembly is elevated relative to the lowered configuration such that the EV battery is elevated from the fuel unit pallet;

FIG. 7E is a perspective view of the two-post lift assembly of FIG. 7A, the EV battery of FIG. 7A, and the pair of fuel unit lifting adapters of FIG. 6 inserted through the pathway defined by the EV battery and the fuel unit pallet, where the two-post lift assembly and the pair of fuel unit lifting adapters are supporting the elevated EV battery, where the fuel unit pallet is removed, where a lift table is moved directly under the elevated EV battery;

FIG. 7F is a perspective view of the two-post lift assembly of FIG. 7A, the EV battery of FIG. 7A, and the pair of fuel unit lifting adapters of FIG. 6 inserted through the pathway defined by the EV battery and the fuel unit pallet, where the two-post lift assembly and the pair of fuel unit lifting adapters are supporting the elevated EV battery, and where a lift table is moved directly under the elevated EV battery;

FIG. 7G is a perspective view of the two-post lift assembly of FIG. 7A, the EV battery of FIG. 7A, and the pair of fuel unit lifting adapters of FIG. 6 inserted through the pathway defined by the EV battery and the fuel unit pallet, where the two-post lift assembly is such that the elevated EV battery is supported by the lift table of FIG. 7E; and

FIG. 8 is a side view of a portion of an alternative two-post lift assembly, the pair of fuel unit lifting adapters of FIG. 6, a fuel unit pallet, and an EV fuel unit resting on the fuel unit pallet, where the fuel unit lifting adapters are engaged with an arm adapter of the two-post lift assembly and the fuel unit while the fuel unit is resting on the pallet and while the pallet is resting on the ground.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the resent invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is, by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. Example of a Fuel Unit Pallet-Lifting Adapters and Frame-Engaging Lift for Lifting a Vehicle Battery and Associated Pallet

As mentioned above, in instances where a replacement EV fuel unit is being installed on an electric vehicle (“EV”), a forklift may be used to lift a fuel unit pallet supporting the replacement EV battery and place that fuel unit pallet on a lift table to suitably position the replacement EV battery for installation. However, utilizing a forklift to raise and position a fuel unit pallet and supported EV battery may be overly difficult to control.

For example, after lifting a fuel unit pallet and replacement EV battery with a forklift, it may be difficult to precisely position the fuel unit pallet on a lift table via movement of the forklift such that the fuel unit pallet and EV battery are suitably supported by the lift table. In some instances, it may be difficult to suitably lower a fuel unit pallet onto a lift table via a forklift such that the forklift does not accidentally damage the lift table. In other instances, it may be difficult to suitably align the fuel unit pallet with the supporting surface of a lift table such that the fuel unit pallet suitably engages the lift table once lowered via forklift. As another example, after lifting a fuel unit pallet and replacement EV battery with a forklift, it may be difficult to move a lift table around the forklift such that the lift table suitably supports the fuel unit pallet and replacement EV battery when the forklift lowers the fuel unit pallet onto the lift table. Therefore, in some instances, it may be desirable to lift a fuel unit pallet supporting an EV battery with greater control such that it is easier to (A) position a lift table underneath a lifted fuel unit pallet and EV battery, and (B) lower a fuel unit pallet and EV battery onto a lift table.

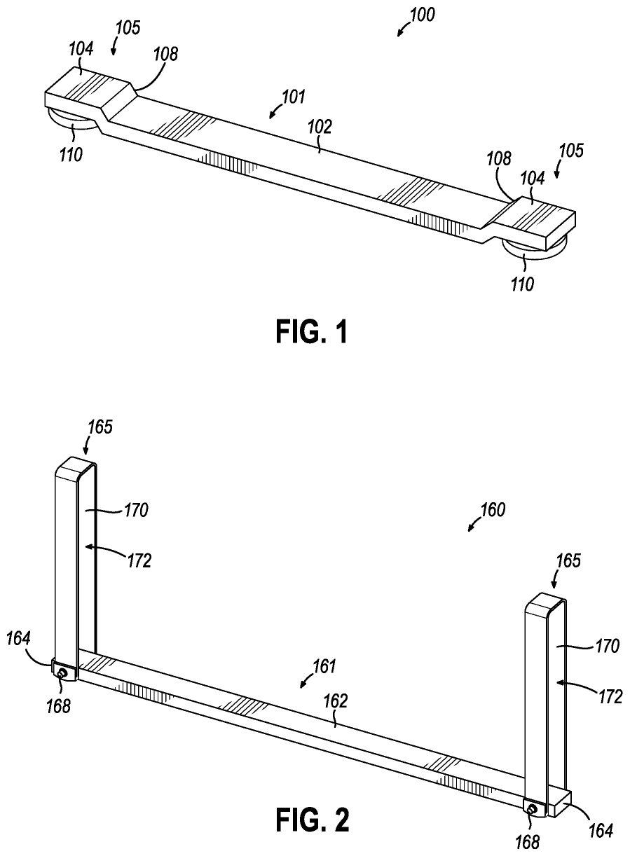

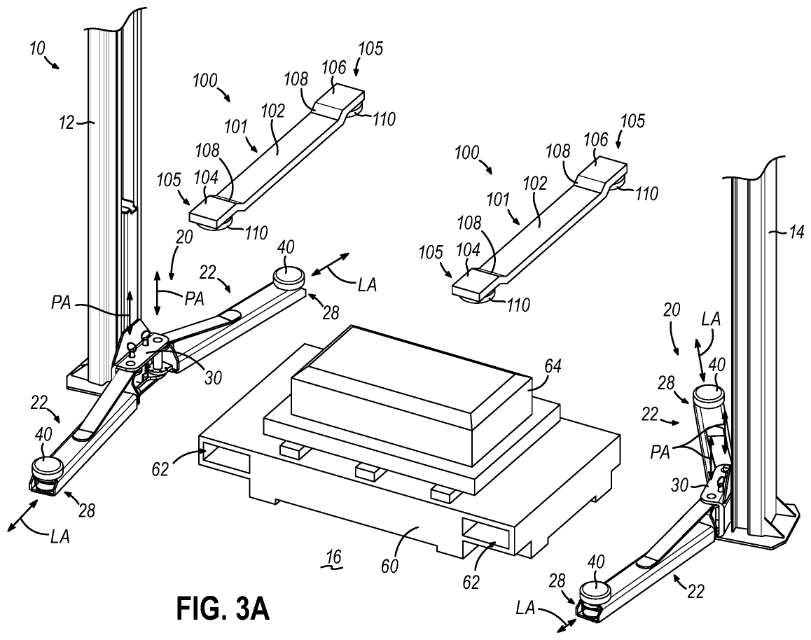

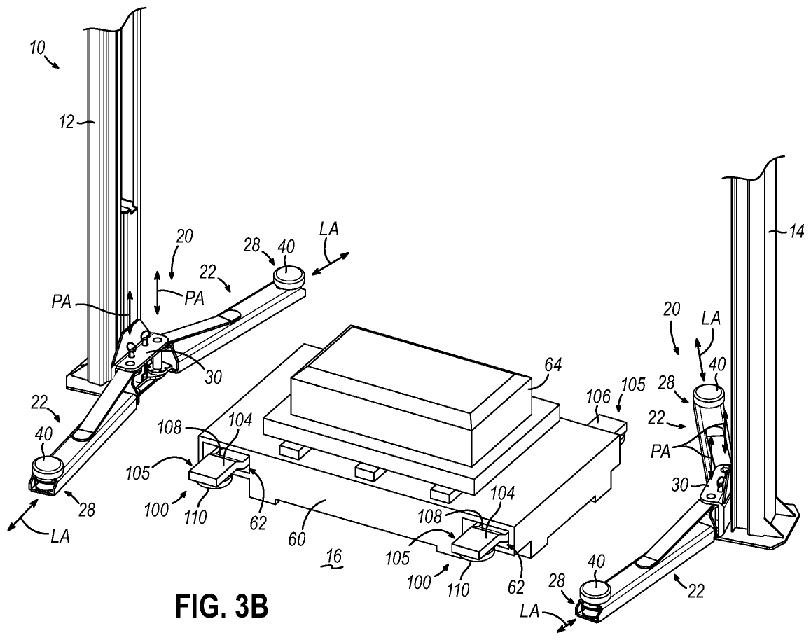

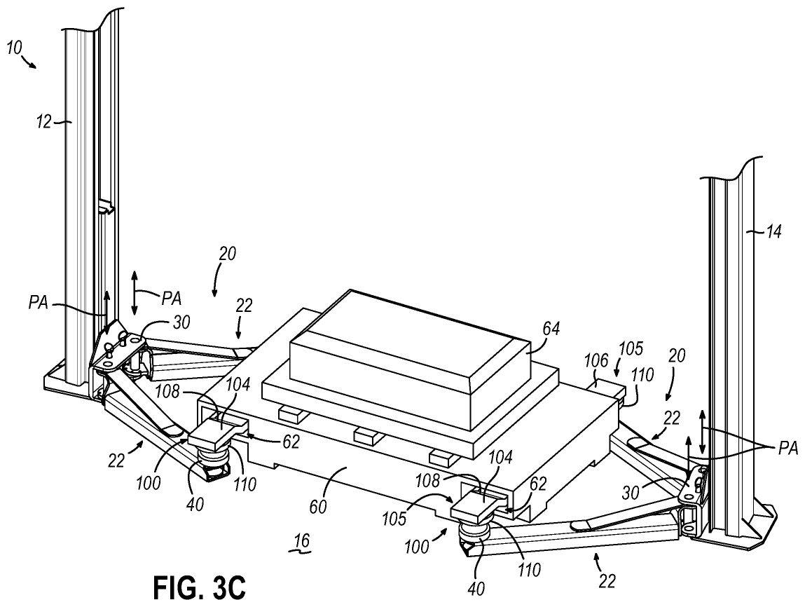

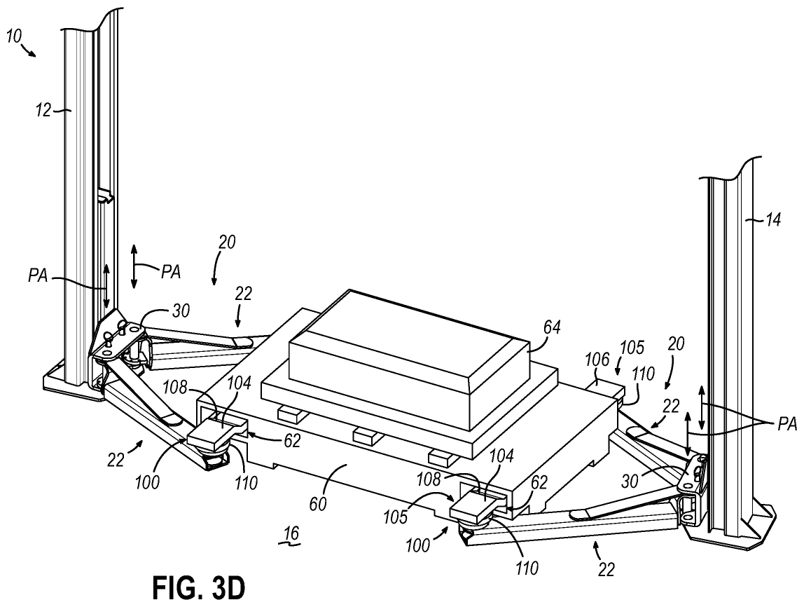

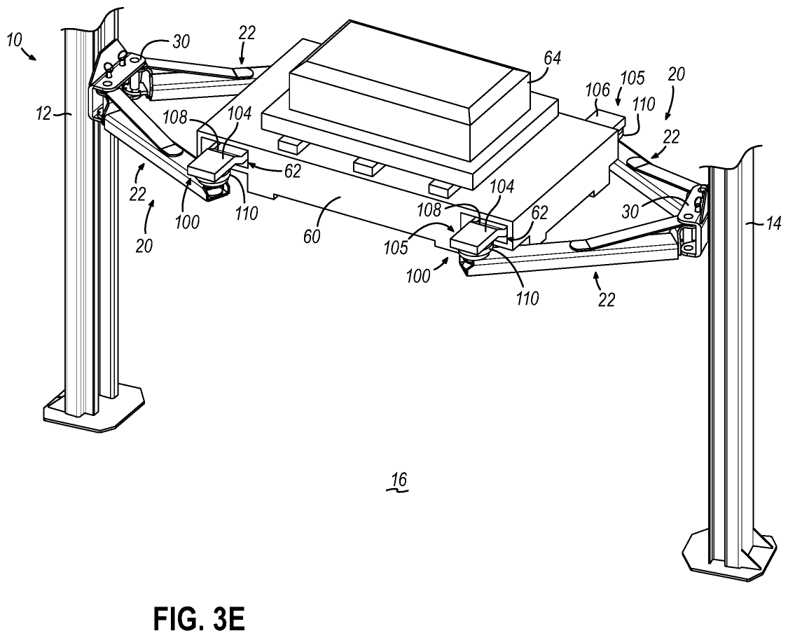

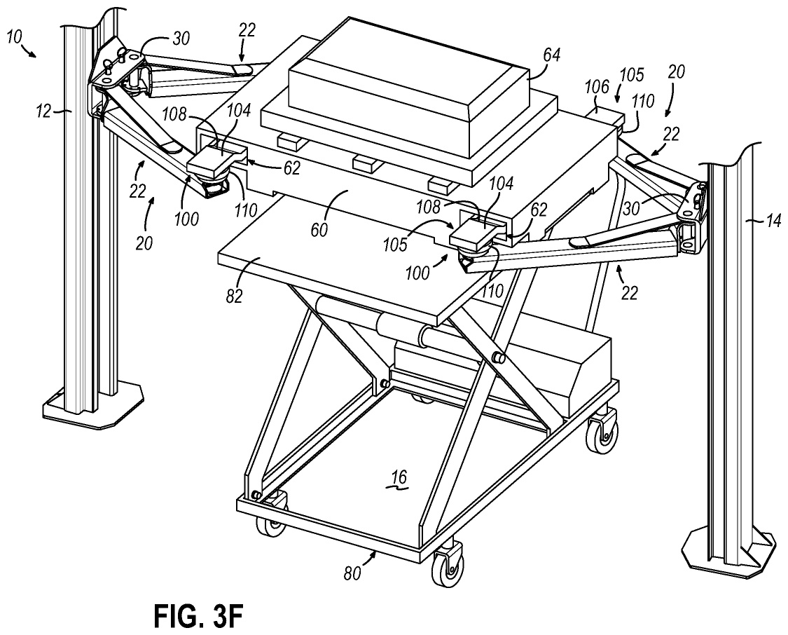

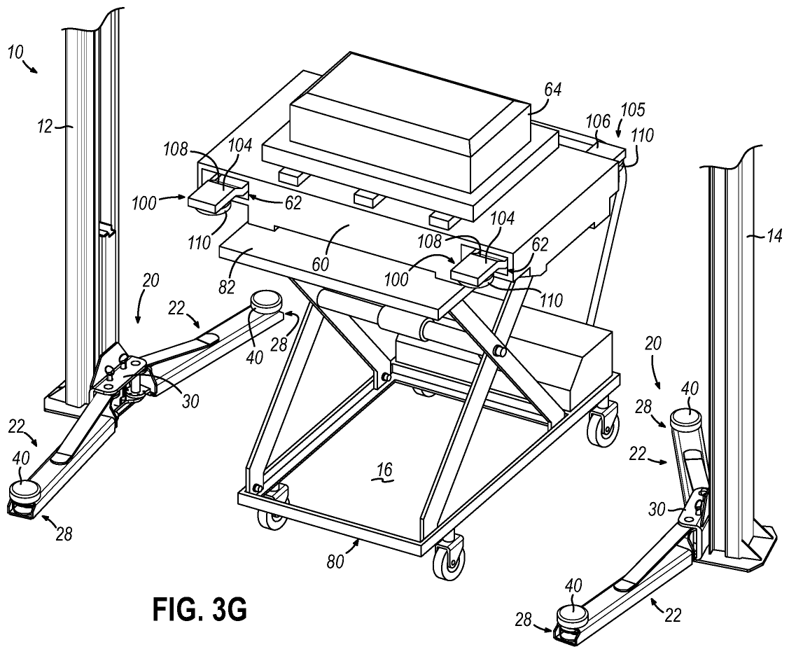

FIG. 1 shows a first fuel unit pallet-lifting adapter (100), while FIG. 2 shows a second fuel unit pallet-lifting adapter (160). As will be described in greater detail below, a pair of fuel unit pallet-lifting adapters (100, 160) may be used in conjunction with a vehicle lift, such as two-post lift (10) (see FIGS. 3A-5) described below, in order to lift a fuel unit pallet (60) (see FIGS. 3A-5) and an EV battery (64) (see FIGS. 3A-5) with sufficient control in order to suitably place the lifted fuel unit pallet (60) and EV battery (64) on a support surface (82) (see FIGS. 3F-3G, 4E-4G, and 7E-7G) of a lift table (80) (see FIGS. 3F-3G, 4E-4G, and 7E-7G).

Turning to FIG. 1, fuel unit pallet-lifting adapter (100) includes a centralized pallet-engaging portion (101) terminating at each end into an outer lift-engaging portion (105). In the current example, pallet-engaging portion (101) includes an elongated connecting bar (102). Elongated connecting bar (102) is dimensioned to be slidingly inserted through pathway (62) defined by fuel unit pallet (60). Elongated connecting bar (102) has a suitable length to extend entirely through a pathway (62) (see FIGS. 3A-5) of fuel unit pallet (60) when suitably coupled to fuel unit pallet (60) such that lift-engaging portions (105) extend laterally out of pathways (62). Elongated connecting bar (102) is formed of suitable material such that connecting bar (102) may suitably transmit the load of supporting fuel unit pallet (60) and EV battery (64) onto a vehicle lift, such as two-post lift (10) (see FIGS. 3A-5), without failing. Elongated connecting bar (102) may be formed out of any suitable material as would be apparent to one skilled in the art in view of the teachings herein. For example, elongated connecting bar (102) may be formed of a suitable metal, alloy, wood, composite, or plastic.

Outer lift-engaging portion (105) includes a first elevated end (104) and a second elevated end (106) located on opposite sides of elongated connecting bar (102). Each elevated end (104, 106) include a lifting engagement structure (110) extending downwardly from elevated ends (104, 106) such that lifting engagement structures (110) are adjacent to terminating ends of connecting bars (102).

Elongated connecting bar (102) is connected to each elevated end (104, 106) via sloped transition sections (108). Elevated ends (104, 106) are sufficiently raised from elongated connecting bar (102) in order to provide a space for select portions of a vehicle lift to suitably access lifting engagement structures (110) while (A) fuel unit pallet (60) is resting on the ground, and (B) fuel unit pallet-lifting adapter (100) is inserted through pathway (62) of fuel unit pallet (60). In other words, elevated ends (104, 106) sufficiently elevate lifting engagement structure (110) such that there is a suitable gap between the shop floor (16) and lifting engagement structures (110) prior to a vehicle lift contacting lifting engagement structures (110), as such a gap provides sufficient space to allow a lifting component of a vehicle lift to suitably align with lifting engagement structures (110).

Similar to elongated connecting bar (102), elevated ends (104, 106) and lifting engagement structures (110) are formed of a suitable material such that connecting bar (102) may suitably transmit the load of supporting fuel unit pallet (60) and EV battery (64) onto a vehicle lift without failing. In some instances, elongated connecting bar (102), sloped transition sections (108), and elevated ends (104, 106) may be formed from a unitary piece of material, although this is merely optional. Additionally, while in the current example sloped transition sections (108) extend upwardly at a gradual angle, this is merely optional. In some instances, transition sections (108) may extend upwardly in a step-like fashion.

Lifting engagement structures (110) are dimensioned to mate with a corresponding lifting feature of a vehicle lift, such as an arm adapter (40) (see FIGS. 3A-5) of two-post lift (10) described below. In some instances, lifting engagement structures (110) provide a planar surface to engage arm adapter (40) (see FIGS. 3A-5). In other instances, lifting engagement structure (110) includes a body defining a complementary cavity dimensioned to receive arm adapter (40). As will be described in greater detail below, a technician may insert fuel unit pallet-lifting adapter (100) through pathways (62) of fuel unit pallet (60) such that lifting engagement structures (110) may align and mate with a respective arm adapter (40) such that raising and lowering of arm adapter (40) may raise and lower fuel unit pallet-lifting adapters (100), fuel unit pallet (60), and EV battery (64). As will also be described in greater detail below, two-post lift (10) and a pair of fuel unit pallet-lifting adapters (100) may keep fuel unit pallet (60) and EV battery (64) sufficiently elevated in a control manner such that a shop technician may suitably place a lift table (80) under fuel unit pallet (60) and then controllably lower fuel unit pallet (60) onto lift table (80) such that lift table (80) supports fuel unit pallet (60) and EV battery (64) rather than two-post lift (10).

Turning to FIG. 2, fuel unit pallet-lifting adapter (160) includes a centralized fuel unit pallet-engaging portion (161) terminating at each end into an outer lift-engaging portion (165). Similar to fuel unit pallet-engaging portion (101) described above, fuel unit pallet-engaging portion (161) includes an elongated connecting bar (162). Elongated connecting bar (162) is substantially similar to elongated connecting bar (102) described above, with differences elaborated below. Therefore, elongated connecting bar (162) is dimensioned to be slidingly inserted through pathway (62) defined by fuel unit pallet (60). Elongated connecting bar (162) has a suitable length to extend entirely through a pathway (62) (see FIGS. 3A-5) of fuel unit pallet (60) when suitably coupled to fuel unit pallet (60) such that lift-engaging portions (165) extend laterally out of pathways (62). Elongated connecting bar (162) is formed of suitable material such that connecting bar (162) may suitably transmit the load of supporting fuel unit pallet (60) and EV battery (64) onto a vehicle lift, such as two-post lift (10) (see FIGS. 3A-5), without failing. Elongated connecting bar (162) may be formed out of any suitable material as would be apparent to one skilled in the art in view of the teachings herein. For example, elongated connecting bar (162) may be formed of a suitable metal, alloy, wood, composite, plastic, etc.

In comparison to outer lift-engaging portion (105) described above, outer lift-engaging portion (165) includes a pair of straps (170) coupled to a respective end (164) of lift bar (162) via a strap attachment (168). Straps (170) may be suitably coupled to ends (164) of connecting bar (162) utilizing any features that would be apparent to one skilled in the art in view of the teachings herein. Straps (170) are coupled to lift bar (162) in such a way such that each strap (170) defines a strap loop (172). Strap loop (172) is dimensioned to be inserted over a lifting component of a vehicle lift, such a lift arm (22) of two-post lift (10) (see FIGS. 3A-5). Straps (170) include a sufficient lifting capacity and are sufficiently coupled to connecting bar (162) such that straps (170) may help lift fuel unit pallet (60) and EV battery (64) in accordance with the description herein without tearing or disassociating from connecting bar (162). While in the current example, one end of strap (170) and another end of strap (170) couple to connecting bar (162) in order to form looped pathway (172), this is merely optional. Strap (170) may include a single price of strapping coupling to connecting bar (162) that diverges at the opposite end to form looped pathway (172). Straps (170) may have any suitable geometry as would be apparent to one skilled in the art in view of the teachings herein.

As will also be described in greater detail below, two-post lift (10) and a pair of fuel unit pallet-lifting adapters (160) may keep fuel unit pallet (60) and EV battery (64) sufficiently elevated in a controlled manner such that a shop technician may suitably place a lift table (80) under fuel unit pallet (60) and then controllably lower fuel unit pallet (60) onto lift table (80) such that lift table (80) supports fuel unit pallet (60) and EV battery (64) rather than two-post lift (10).

FIG. 3A-5 show an example of a frame-engaging vehicle lift, a two-post lift (10), that can be used to raise a vehicle, allow access to the underside of the vehicle, and allow wheels and tires of the vehicle to be removed or serviced. While the current frame-engaging vehicle lift is two-post lift (10), any other suitable frame-engaging vehicle lift may be used as would be apparent to one skilled in the art in view of the teachings herein. For example, the frame-engaging vehicle lift may be a scissor-lift assembly, a four-post lift, an in-ground lift, one or more portable lifts, etc.

Two-post lift (10) includes a pair of lift posts (12, 14) and a pair of lifting carriages (20) operatively coupled to a respective lift post (12, 14). Lift posts (12, 14) extend upwardly from a floor (16) to an elevated portion (not shown). In some instances, while entirely optional, a crossbar (not shown) may extend between lift posts (12, 14) near the top of two-post lift (10) to provide at least some degree of structural stability between lift posts (12, 14).

Lifting carriages (20) are configured to synchronously actuate along a path defined by respective lift posts (12, 14) between a lowered position near floor (16) and a raised position above floor (16). Lifting carriages (20) may also selectively lock into place relative to respective lift posts (12, 14) such that lifting carriages (20) may be prevented from inadvertently lowering once reaching a desired height. Therefore, lift posts (12, 14) may provide a mechanical path for respective lifting carriages (20) to actuate along. Any suitable components to promote synchronous actuation and locking of lifting carriages (20) relative to lift posts (12, 14) may be used as would be apparent to one skilled in the art in view of the teachings herein.

Lifting carriages (20) are configured to engage the frame of a vehicle such that as lifting carriages (20) actuate between the lowered position and the raised position, the vehicle will also be lifted and lowered between a corresponding lowered and raised position. However, as will be described in greater detail below, lifting carriages (20) may be used in conjunction with fuel unit pallet-lifting adapters (100, 160) in order to (A) engage a fuel unit pallet supporting an EV battery, and to (B) actuate the fuel unit pallet between a corresponding lowered and raised position. Therefore, lifting carriage (20) and fuel unit pallet-lifting adapters (100, 160) may be configured to promote lifting a fuel unit pallet and EV battery for placing the fuel unit pallet and EV battery onto a lift table for purposes of installation on an electrical vehicle.

Each lifting carriage (20) includes a base frame (30) and a pair of adjustable lifting arms (22) configured to be adjusted relative to their respective base frame (30) and relative to each other in order to suitably engage a vehicle frame. Base frames (30) suitably engage their respective lift post (12, 14) such that lifting carriages (20) may synchronously actuate along their path defined by lift posts (12, 14).

Each lifting arm (22) is pivotally coupled to base frame (30) of the respective carriage (20) about a respective pivot axis (PA). Lifting arms (22) may be pivotally coupled to base frame (30) via pivot pin or any other suitable structure as would be apparent to one skilled in the art in view of the teachings herein. In some instances, lifting arms (22) may include telescoping segments configured to actuate relative to each other along a linear path defined by a respective longitudinal axis (LA) into various lengths.

Each lifting arm (22) terminates into an adapter coupling end (28) is configured to selectively couple with various arm adapters, such as arm adapter (40). Arm adapters (40) may be configured to suitably engage vehicle frames such that lifting carriages (20) may lift vehicles in accordance with the description herein.

Two-post lift (10) may be connected to a power supply (not pictured) to provide power to various components of two-post lift (10), such as a control assembly (not shown) and a drive assembly (not shown). Control assembly (not shown) is operatively connected to drive assembly (not shown) such that an operator may utilize control assembly (not shown) to selectively activate drive assembly (not shown). Drive assembly (not shown) is configured to raise and lower carriages (20) in accordance with the description herein by producing mechanical energy that is translated to a lifting motion of the carriages (20) through a mechanical linkage, hydraulic system, other systems, or any combination thereof as will be apparent to one skilled in the art in view of the teachings herein.

### II. Example of Using Adapters and Frame-Engaging Lift Lifting a Vehicle Battery and Associated Pallet

FIGS. 3A-3G show an example of using two-post lift (10) and a pair of fuel unit pallet-lifting adapters (100) used to lift fuel unit pallet (60) and an associated EV battery (64) off the shop floor (16) and onto a supporting surface (82) of a lift table (80). First, as shown in FIG. 3A, a technician may place fuel unit pallet (60), which supports an associated EV battery (64), onto shop floor (16) in-between posts (12, 14). Fuel unit pallet (60) may be placed onto shop floor (16), as shown in FIG. 3A, utilizing any suitable means as would be apparent to one skilled in the art in view of the teaching herein. For example, a technician may lift fuel unit pallet (60) with a forklift by inserting forks through a respective pathways (62) and lowering fuel unit pallet (60) onto shop floor (16) between posts (12, 14). In such instances, each pathway (62) may be located closer to one post (12, 14) than the other post (12, 14). Each pathway (62) defined by fuel unit pallet (60) includes a terminal end facing a respective lifting arm (22) of a carriage (20). Next, as shown in FIG. 3B, with fuel unit pallet (60) suitably placed on shop floor (16), a technician may insert a respective fuel unit pallet-lifting adapter (100) within a pathway (62) such that fuel unit pallet-engaging portion (101) is slidably housed within pathway (62) and ends (104, 106) extends laterally out of pathway (62) toward a respective lifting arm (22) of a carriage (20). It should be understood that at the point shown in FIG. 3B, fuel unit pallet-engaging portion (101) of adapter (100) may be actuated upward to engage the underside of fuel unit pallet (60).

Next, as shown in FIG. 3C, arms (22) may be adjusted relative to base (30) in order to suitable align arm adapters (40) with lift engagement structures (110). Arms (22) may be rotated about their respective pivot axis (PA) and adjusted along their respective longitudinal axis (LA) until arm adapters (40) are suitably aligned underneath lift engagement structures (110). As shown between FIGS. 3C-3D, with arm adapters (40) and lift engagement structures (110) suitably aligned, a technician may raise carriages (20) in accordance with the description herein until arm adapter (40) of lift arms (22) suitably engage lift engagement structures (110). As the moment shown in FIG. 3D, fuel unit pallet engagement portion (101) of adapter (100) may be lifted into suitable engagement with a portion of fuel unit pallet (60) defining pathway (62).

Next, as shown in FIG. 3E, a technician may raise carriages (20) such that arms (22) raise fuel unit pallet-lifting adapters (100), fuel unit pallet (60), and EV battery (64) to a desired height. It should be understood that at the moment shown in FIG. 3E, two-post lift (10) may mechanically lock carriages (20) at the elevated position shown such that carriages (20) do not inadvertently lower. With carriages (20), fuel unit pallet (60), and EV battery (64) in the raised position shown in FIG. 3E, a technician may position a lift table (80) directly under fuel unit pallet (60), as shown in FIG. 3F.

Next, a technician may either (A) raise lift table (80) such that a supporting surface (82) of lift table (80) engages fuel unit pallet (60), or (B) lower carriages (20) such that fuel unit pallet (60) is lowered into engagement with supporting surface (82) of lift table (80). As shown in FIG. 3G, once supporting surface (82) of lift table (80) engages fuel unit pallet (60), a technician may lower carriages (20) in accordance with the description herein such that two-post lift (10) no longer engages adapters (100). With fuel unit pallet (60) placed on supporting surface (82) of lift table (80), a technician may now suitably move lift table (80), fuel unit pallet (60), and EV battery (64) around shop floor (16) in order to install EV battery (64).

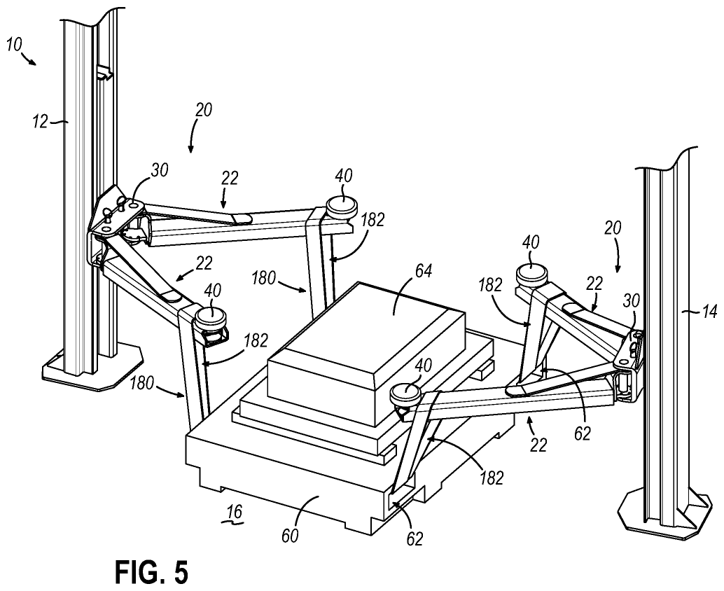

In the current example, prior to inserting adapters (100) within pathways (62), fuel unit pallet (60) is placed on shop floor (16) such that when adapters (100) are interested through pathways (62), each adapter (100) is configured to a engage an arm (22) associated with the same carriage (20). However, this is merely optional, as fuel unit pallet (60) may be placed on shop floor (16) such that when adapters (100) are inserted through pathways (62), each adapter may be configured to engage an arm (22) associated with a carriage (20) of each post (12, 14) (similar to the orientation of fuel unit pallet (60) as shown in FIG. 5)

It should be understood that while, in the current example, fuel unit pallet (60) defines a pathway (62) which interacts with adapters (100), this is merely optional. Adapters (100) may be configured to be located underneath fuel unit pallet (60) such that adapters (100) engage an underside of fuel unit pallet (60) in order to lift fuel unit pallet (60). Alternatively, fuel unit pallet (60) may simply define a partial recessed area that restrains adapter (100) during exemplary use in accordance with the description herein.

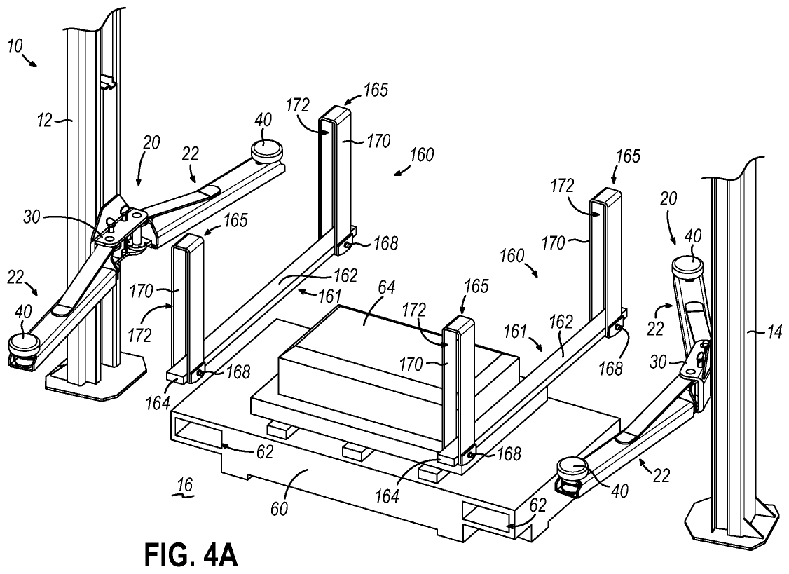

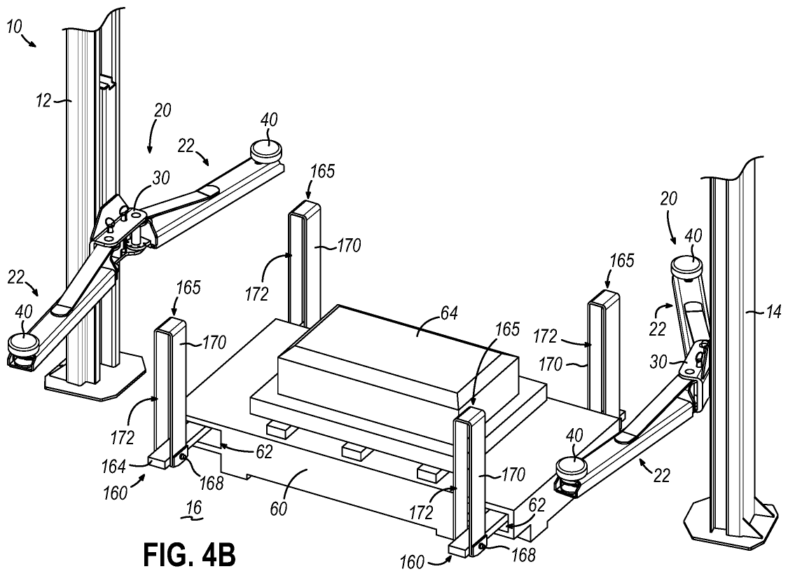

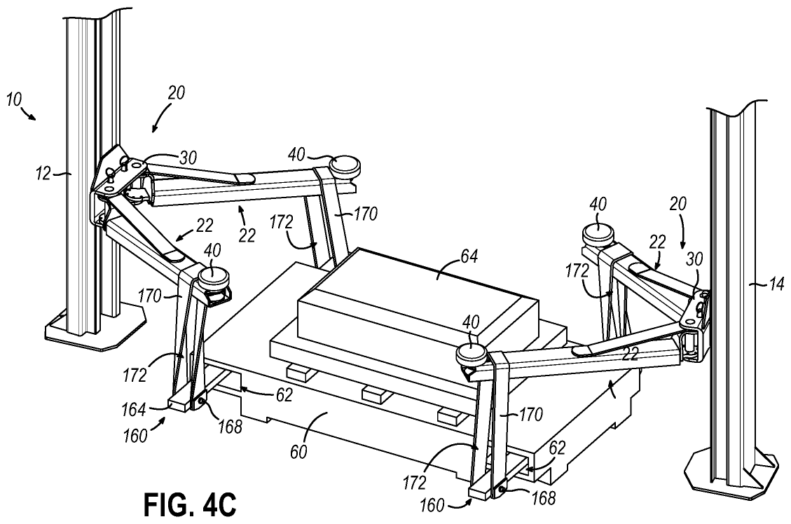

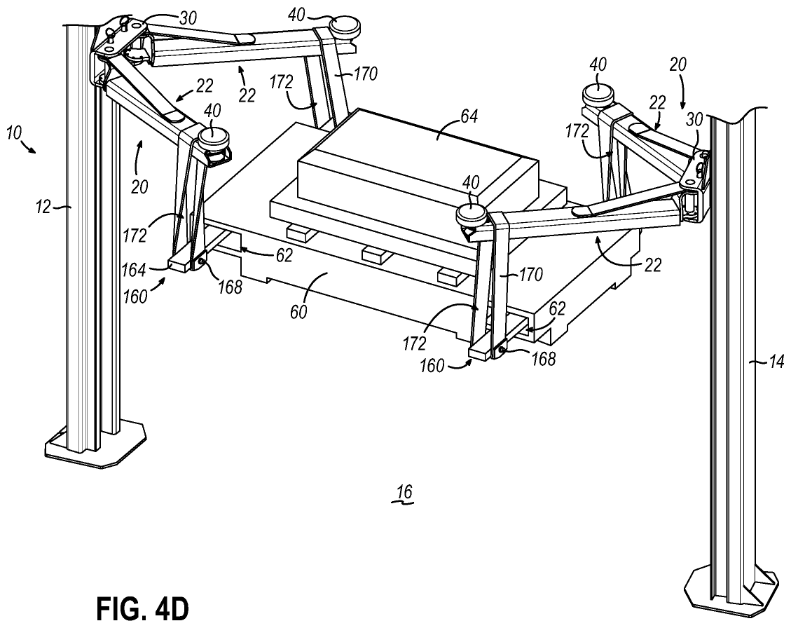

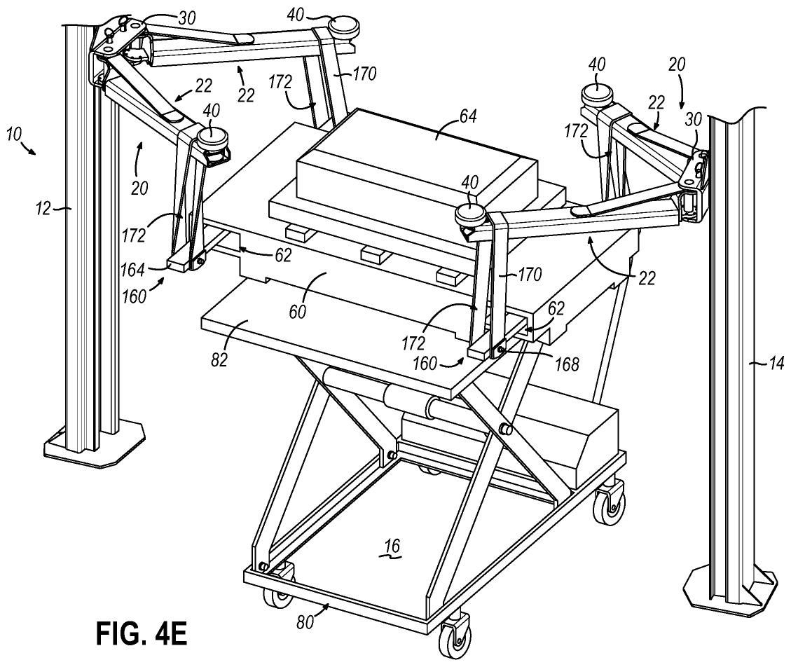

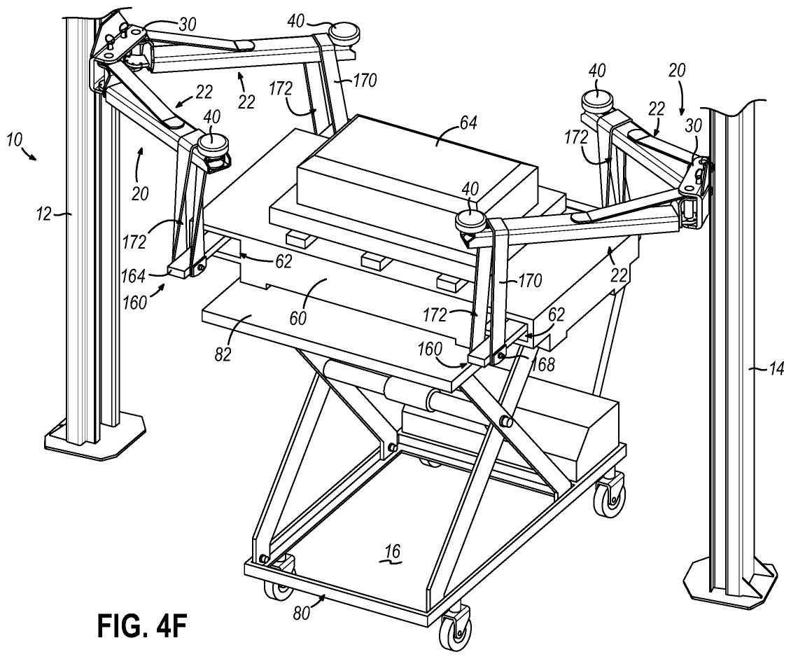

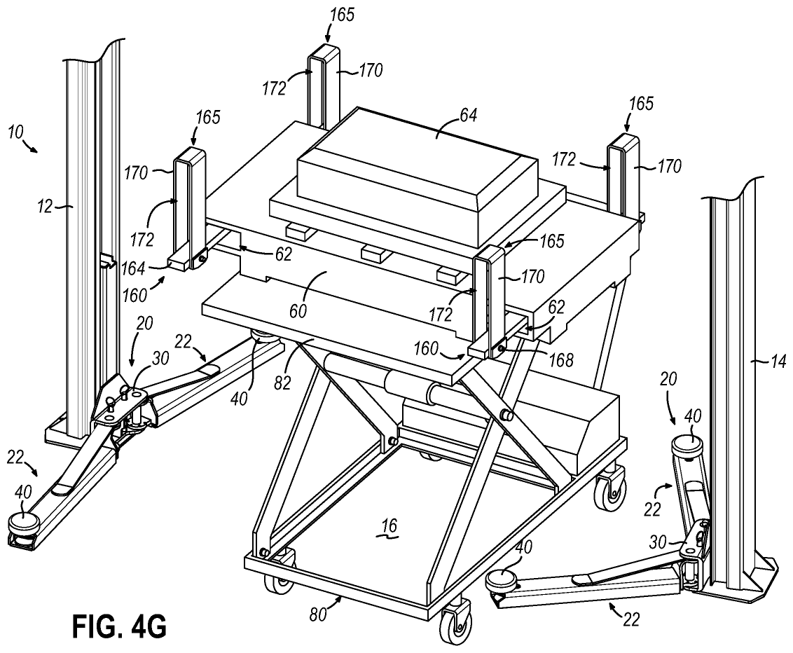

FIGS. 4A-4G show an example of using of two-post lift (10) and a pair of fuel unit pallet-lifting adapters (160) used to lift fuel unit pallet (60) and an associated EV battery (64) off the shop floor (16) and onto a supporting surface (82) of a lift table (80). First, as shown in FIG. 4A, a technician may place fuel unit pallet (60), which supports an associated EV battery (64), onto shop floor (16) in-between posts (12, 14). Fuel unit pallet (60) may be placed onto shop floor (16), as shown in FIG. 3A, utilizing any suitable means as would be apparent to one skilled in the art in view of the teaching herein. Each pathway (62) defined by fuel unit pallet (60) includes a terminal end facing a respective lifting arm (22) of a carriage (20). It should be understood that in the current example, carriages (20) may already be raised to a partially elevated position above fuel unit pallet (60).

Next, as shown in FIG. 4B, with fuel unit pallet (60) suitably placed on shop floor (16), a technician may insert a respective fuel unit pallet-lifting adapter (160) within a pathway (62) such that fuel unit pallet engaging portion (161) is slidably housed within pathway (62) and ends (164) extend laterally out of pathway (62) toward a respective lifting arm (22) of a carriage (20). It should be understood that at the point shown in FIG. 4B, fuel unit pallet-engaging portion (161) of adapter (160) may be actuated upward to engage the underside of fuel unit pallet (60).

Next, as shown in FIG. 4C, arms (22) may be adjusted relative to base (30) in order to suitably align arm adapters (40) with straps (170) such that straps (170) may suitably engage arms (22) via strap loop (172). Arms (22) may be rotated about their respective pivot axis (PA) and adjusted along their respective longitudinal axis (LA) until straps (170) reach the terminal end of arms (22). As shown between FIGS. 4C-4D, with straps (170) suitably engaged with arms (22), a technician may raise carriages (20) in accordance with the description herein until arms (22) raise fuel unit pallet-lifting adapters (160), fuel unit pallet (60), and EV battery (64) to a desired height. It should be understood that at the moment shown in FIG. 4D, two-post lift (10) may mechanically lock carriages (20) at the elevated position shown such that carriages (20) do not inadvertently lower. With carriages (20), fuel unit pallet (60), and EV battery (64) in the raised position shown in FIG. 4D, a technician may position a lift table (80) directly under fuel unit pallet (60), as shown in FIG. 4E.

Next, as shown in FIG. 4F a technician may either (A) raise lift table (80) such that a supporting surface (82) of lift table (80) engages fuel unit pallet (60), or (B) lower carriages (20) such that fuel unit pallet (60) is lowered into engagement with supporting surface (82) of lift table (80). As shown in FIG. 4G, once supporting surface (82) of lift table (80) engages fuel unit pallet (60), a technician may decouple straps (170) from arms (22) such that two-post lift (10) no longer engages adapters (160) and lowers carriages (20) in accordance with the description herein. With fuel unit pallet (60) placed on supporting surface (82) of lift table (80), a technician may now suitably move lift table (80), fuel unit pallet (60), and EV battery (64) around shop floor (16) in order to install EV battery (64).

In the current example, prior to inserting adapters (160) within pathways (62), fuel unit pallet (60) is placed on shop floor (16) such that when adapters (160) are inserted through pathways (62), each adapter (160) is configured to a engage an arm (22) associated with the same carriage (20). However, this is merely optional, as fuel unit pallet (60) may be placed on shop floor (16) such that when adapters (160) are inserted through pathways (62), each adapter may be configured to engage an arm (22) associated with a carriage (20) of each post (12, 14) (similar to the orientation of fuel unit pallet (60) as shown in FIG. 5). It should be understood that while in the current example, fuel unit pallet (60) defines a pathway (62) which interact with adapters (160), this is merely optional. Adapters (160) may be configured to be located underneath fuel unit pallet (60) such that adapters (160) engage an underside of fuel unit pallet (60) in order to lift fuel unit pallet (60). Alternatively, fuel unit pallet (60) may simply define a partial recessed area that restrains adapter (160) during exemplary use in accordance with the description herein.

While in the example shown in FIGS. 4A-4G, adapters (160) include a connecting bar (102) with straps (170), this may be optional. In some instances, as shown in FIG. 5, adapters (180) may include just a strap that defines a pair of looped openings (182) configured to engage arms (22). Therefore, a strap of adapter (180) may be fed through pathway (62) such that a portion of the strap forms both the fuel unit pallet-engaging portion and the lift-engaging portion.

### III. Example of Fuel Unit Lifting Adapters and Frame-Engaging Lift for Lifting a Vehicle Battery

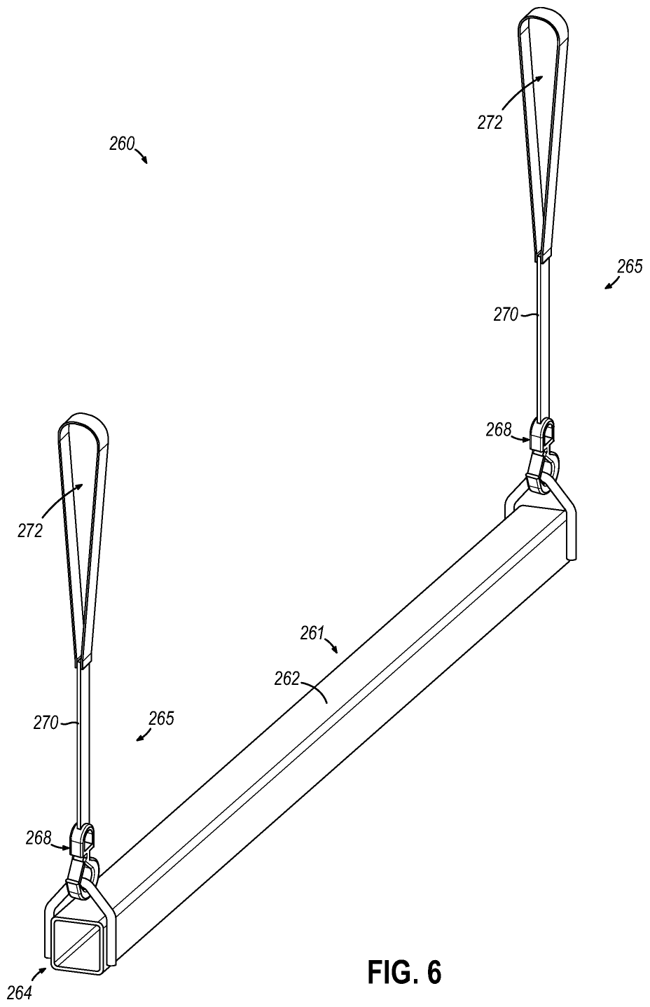

FIG. 6 shows a first fuel unit lifting adapter (260). As will be described in greater detail below, a pair of fuel unit lifting adapters (260) may be used in conjunction with a vehicle lift, such as two-post lift (10) (see FIGS. 3A-5) described below, in order to lift an EV battery (64) from a pallet (60) (see FIGS. 3A-5) with sufficient control in order to suitably place the lifted EV battery (64) on a support surface (82) (see FIGS. 3F-3G, 4E-4G, and 6E-6G) of a lift table (80) (see FIGS. 3F-3G, 4E-4G, and 7E-7G).

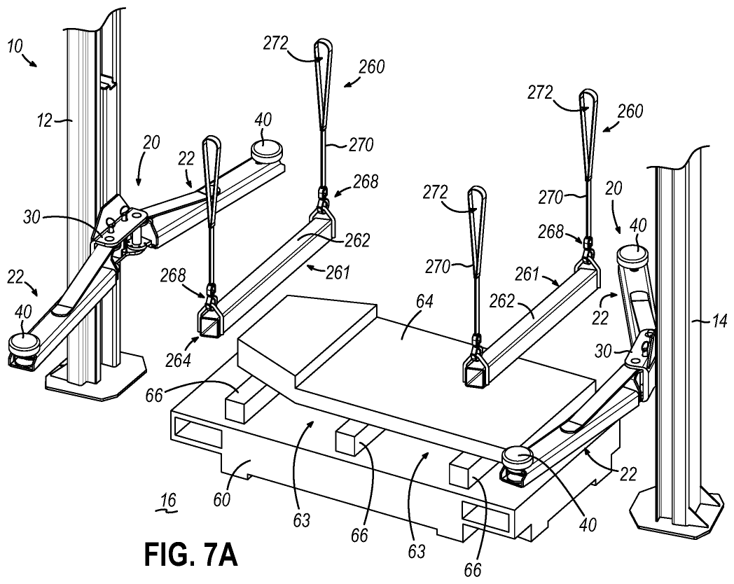

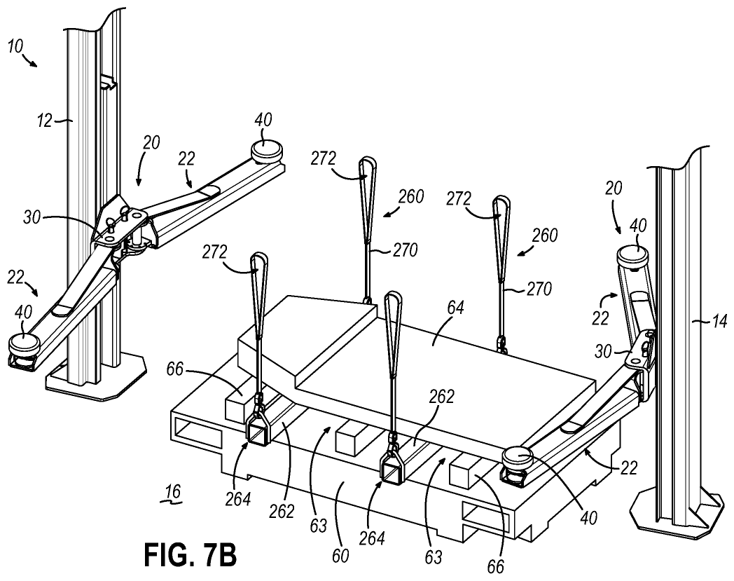

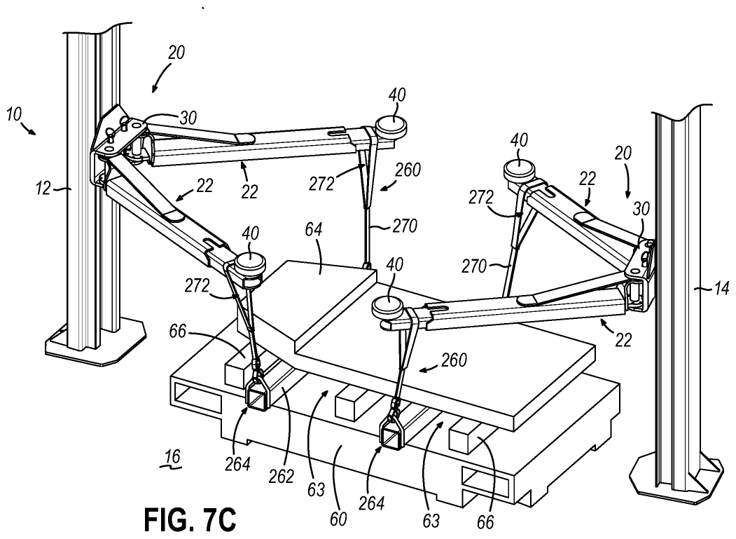

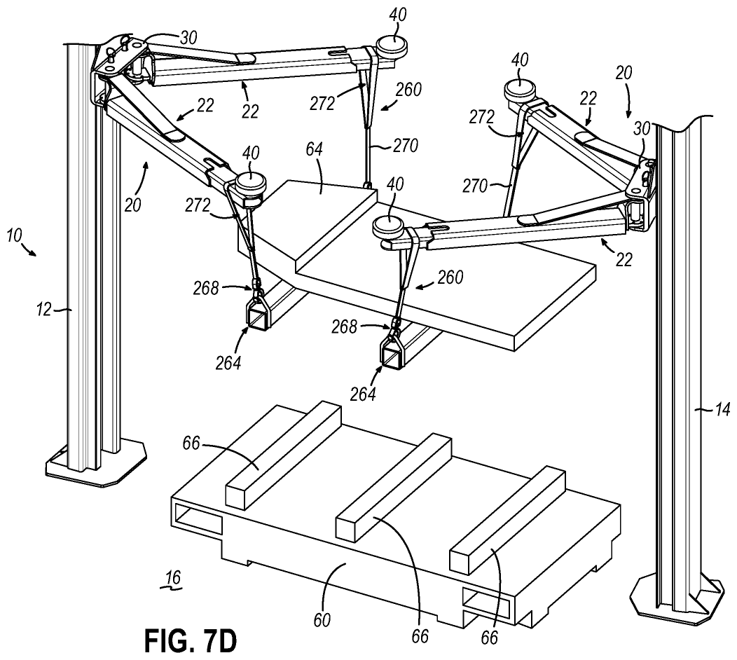

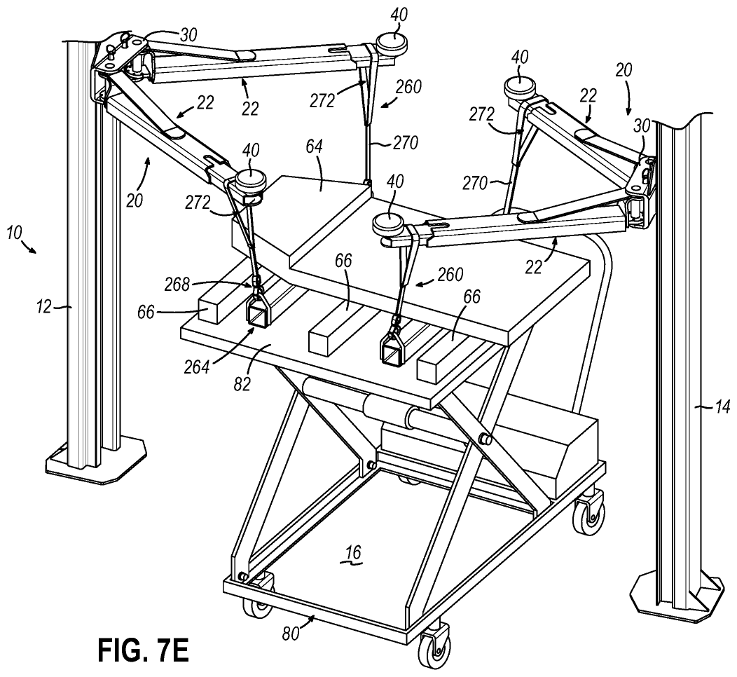

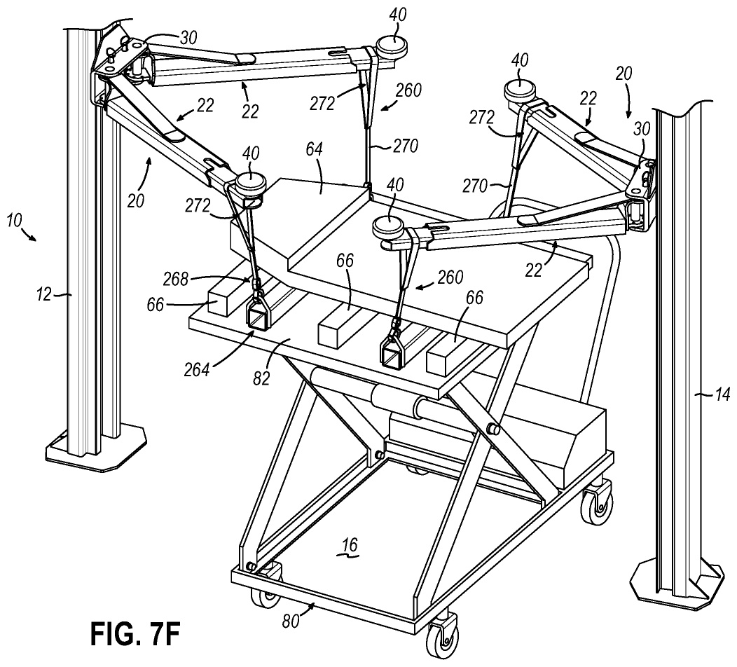

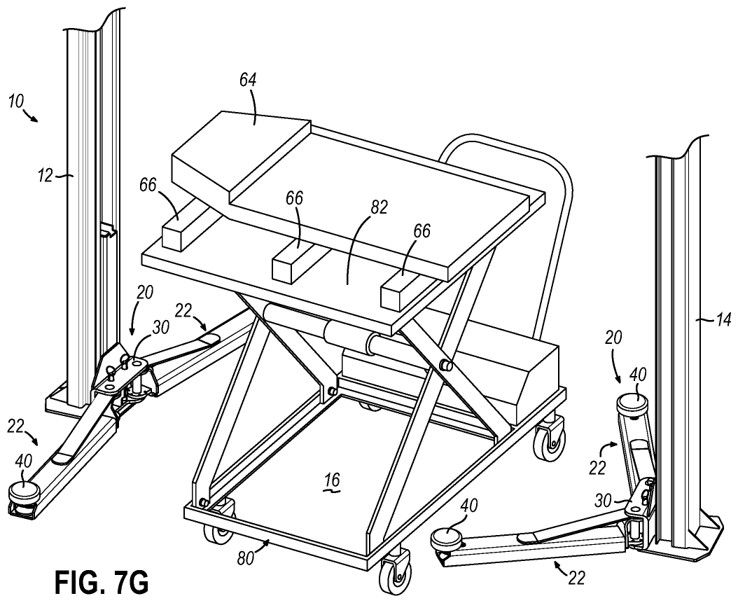

Fuel unit lifting adapter (260) includes a centralized fuel unit engaging portion (261) terminating at each end into an outer lift-engaging portion (265). Similar to fuel unit pallet-engaging portion (101, 161) described above, fuel unit engaging portion (261) includes an elongated connecting bar (262). Elongated connecting bar (262) is substantially similar to elongated connecting bar (102, 162) described above, with differences elaborated below. Therefore, elongated connecting bar (262) is dimensioned to be slidingly inserted through pathway (63). Pathway (63) includes a gap defined by fuel unit pallet (60) and EV battery (64). Pathway (63) may further be defined by dunnage (66) or shoring placed between fuel unit pallet (60) and the EV battery (64) to provide additional space to allow elongated connecting bar (262) to be placed under the EV battery (64). Elongated connecting bar (262) has a suitable length to extend entirely through pathway (63) (see FIGS. 7A-7G) when suitably coupled to EV battery (64) such that lift-engaging portions (265) extend laterally out of pathways (63). Elongated connecting bar (262) is formed of suitable material such that connecting bar (262) may suitably transmit the load of supporting EV battery (64) onto a vehicle lift, such as two-post lift (10) (see FIGS. 3A-5), without failing. Elongated connecting bar (262) may be formed out of any suitable material as would be apparent to one skilled in the art in view of the teachings herein. For example, elongated connecting bar (262) may be formed of a suitable metal, alloy, wood, composite, plastic, etc.

In comparison to outer lift-engaging portion (105, 165) described above, outer lift-engaging portion (265) includes a pair of straps (270) coupled to a respective end (264) of lift bar (262) via a strap attachment (268). Strap attachment (268) may include a hook, a safety hook, a D-ring, a carabiner, a loop, or any alternative or additional coupling features that would be apparent to one skilled in the art in view of the teachings herein. Straps (270) are coupled to lift bar (262) in such a way such that each strap (270) defines a strap loop (272). Strap loop (272) is dimensioned to be inserted over a lifting component of a vehicle lift, such as lift arm (22) of two-post lift (10) (see FIGS. 3A-5). Straps (270) include a sufficient lifting capacity and are sufficiently coupled to connecting bar (262) such that straps (270) may help lift EV battery (64) in accordance with the description herein without tearing or disassociating from connecting bar (262). While in the current example, one end of strap (270) and another end of strap (270) couple to connecting bar (262) in order to form strap loop (272), this is merely optional. Strap (270) may include a single piece of strapping coupling to connecting bar (262) that diverges at the opposite end to form strap loop (272). Straps (270) may have any suitable geometry as would be apparent to one skilled in the art in view of the teachings herein.

As will also be described in greater detail below, two-post lift (10) and a pair of fuel unit lifting adapters (260) may keep EV battery (64) sufficiently elevated in a controlled manner such that a shop technician may suitably place a lift table (80) under EV battery (64) and then controllably lower EV battery (64) onto lift table (80) such that lift table (80) supports EV battery (64) rather than two-post lift (10).

### IV. Example of Using Adapters and Frame-Engaging Lift to Remove a Vehicle Battery from Associated Pallet

FIGS. 7A-7G show an example of using two-post lift (10) and a pair of fuel unit lifting adapters (260) to lift EV battery (64) from fuel unit pallet (60) and onto a supporting surface (82) of a lift table (80). First, as shown in FIG. 6A, a technician may place fuel unit pallet (60), which supports an associated EV battery (64), onto shop floor (16) between posts (12, 14). Shop floor (16) may also be referred to as “the ground.” Fuel unit pallet (60) may be placed onto shop floor (16), as shown in FIG. 7A, utilizing any suitable means as would be apparent to one skilled in the art in view of the teaching herein. Each pathway (63) defined between EV battery (64) and fuel unit pallet (60) includes a pair of terminal ends. It should be understood that in the current example, carriages (20) may already be raised to a partially elevated position above fuel unit pallet (60).

Next, as shown in FIG. 7B, with fuel unit pallet (60) suitably placed on shop floor (16), a technician may insert a respective fuel unit lifting adapter (260) within a pathway (63) such that fuel unit engaging portion (261) is slidably housed within pathway (63) and ends (264) extend laterally out of pathway (63) toward a respective lifting arm (22) of a carriage (20). A technician may also couple at least a portion of fuel unit lifting adapter (260) directly to EV battery (64), such as coupling strap attachment (268) to a portion of EV battery (64). EV battery (64) may have a removeable structure or permanently affixed structure configured to accept a coupling strap attachment (268) or connecting bar (262). Further, a technician may position connecting bar (262) within strap loop (272) of strap (270) and then extend connecting bar (262) between opposing lift arms (22) of a respective lift post (12, 14) such that connecting bar (262) is supported on a respective end (264) by a respective lift arm (22). In this manner, lift arms (22) may raise connecting bar (262) to thereby raise straps (270) to thereby raise EV battery (64). It should be understood that, at the point shown in FIG. 7B, fuel unit pallet-engaging portion (261) of adapter (260) may be actuated upward to engage the underside of EV battery (64).

Next, as shown in FIG. 7C, arms (22) may be adjusted relative to base (30) in order to suitably align arm adapters (40) with straps (270) such that straps (270) may suitably engage arms (22) via strap loops (272). Arms (22) may be rotated about their respective pivot axis (PA) and adjusted along their respective longitudinal axis (LA) until straps (270) may reach the terminal end of arms (22). As shown between FIGS. 7C-7D, with straps (270) suitably engaged with arms (22), a technician may raise carriages (20) in accordance with the description herein until arms (22) raise fuel unit lifting adapters (260) and EV battery (64) to a desired height. In this manner, EV battery (64) may be separated from fuel unit pallet (60). EV battery (64) may also be coupled to fuel unit pallet (60) such that fuel unit pallet (60) is raised when EV battery (64) is raised (similar to that shown in FIGS. 3A-3G and 4A-4G). It should be understood that at the moment shown in FIG. 7D, two-post lift (10) may mechanically lock carriages (20) at the elevated position shown such that carriages (20) do not inadvertently lower. With carriages (20) and EV battery (64) in the raised position shown in FIG. 7D, a technician may position a lift table (80) directly under EV battery (64) and between fuel unit lifting adapters (260), as shown in FIG. 7E.

Next, as shown in FIG. 7F, a technician may either (A) raise lift table (80) such that a supporting surface (82) of lift table (80) of dunnage (66) positioned on supporting surface (82) engages EV battery (64), or (B) lower carriages (20) such that EV battery (64) is lowered into engagement with supporting surface (82) of lift table (80). As shown in FIG. 7G, once supporting surface (82) of lift table (80) engages EV battery (64), a technician may decouple straps (270) from arms (22) such that two-post lift (10) no longer engages adapters (260) and lowers carriages (20) in accordance with the description herein. With EV battery (64) placed on supporting surface (82) of lift table (80), a technician may now suitably move lift table (80) and EV battery (64) around shop floor (16) in order to install EV battery (64).

In the current example, prior to inserting adapters (260) within pathways (63), fuel unit pallet (60) is placed on shop floor (16) such that when adapters (260) are inserted through pathways (63), each adapter (260) is configured to a engage an arm (22) associated with the same carriage (20). However, this is merely optional, as fuel unit pallet (60) may be placed on shop floor (16) such that when adapters (260) are inserted through pathways (63), each adapter may be configured to engage an arm (22) associated with a carriage (20) of each post (12, 14) (similar to the orientation of fuel unit pallet (60) as shown in FIG. 5). It should be understood that, while in the current example a gap between fuel unit pallet (60) and EV battery (64) defines a pathway (63) that interacts with adapters (260), this is merely optional. Adapters (260) may be configured to be located underneath or within fuel unit pallet (60) such that adapters (260) engage an underside or an interior of fuel unit pallet (60) in order to lift fuel unit pallet (60). Alternatively, fuel unit pallet (60) may simply define a partial recessed area that restrains adapter (260) during exemplary use in accordance with the description herein.

While in the example shown in FIGS. 7A-7G adapters (260) include a connecting bar (202) with straps (270), this is optional. In some instances, as shown in FIG. 5, adapters (180) may include just a strap that defines a pair of looped openings (182) configured to engage arms (22). Therefore, a strap of adapter (180) may be fed through pathway (63) such that a portion of strap (270) forms both the fuel unit engaging portion (261) and the lift-engaging portion (265).

### V. Example Arm Adapter for Lifting a Vehicle Battery

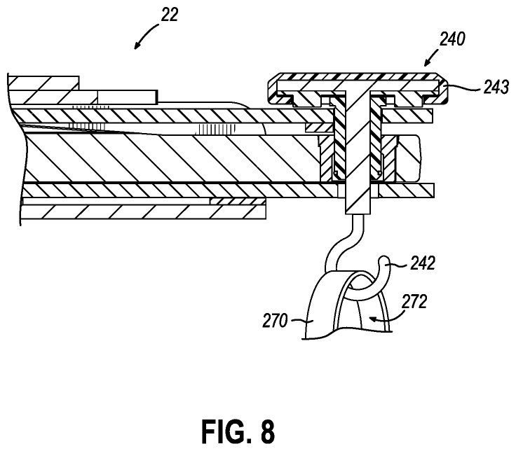

FIG. 8 shows lift arm (22) including an arm adapter (240). Arm adapter (240) may be substantially similar to arm adapter (40) except for the below features. Arm Adapter (240) may include an upper portion configured to rest on top of lift arm (22) and a lower coupling (242). Lower coupling (242) may extend through lift arm (22) and may be configured to couple with strap loop (172, 272) of strap (170, 270). In this manner, a technician may lift EV battery (64) using lower coupling (242) in substantially the same way as shown in FIGS. 4A-4G and 6A-6G but without placing strap loop (172, 272) around lift arm (22), as previously described.

### VI. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A fuel unit assembly-lifting adapter configured to couple with a vehicle lift in order to engage, raise, and lower a fuel unit assembly, the fuel unit assembly-lifting adapter comprising: an elongated fuel unit assembly-engaging portion terminating into a first end and a second end and a lift-engaging portion comprising a first member extending from the first end of the fuel unit assembly-engaging portion, and a second member extending from the second end of the fuel unit assembly-engaging portion, wherein the first member and the second member are configured to detachably engage a vehicle lift such that the fuel unit assembly-engaging portion may raise and lower the fuel unit assembly in response to movement of the vehicle lift.

### Example 2

The fuel unit assembly-lifting adapter of example 1, wherein each of the first and second members include a respective strap defining a loop, wherein the respective strap is configured to engage the vehicle lift.

### Example 3

The fuel unit assembly-lifting adapter of example 2, wherein the loop is configured to loop around a portion of the vehicle lift to thereby couple with the vehicle lift to thus engage, raise, and lower the fuel unit assembly with motion of the portion of the vehicle lift.

### Example 4

The fuel unit assembly-lifting adapter of example 1, wherein the first member is configured to selectively engage the first end of the fuel unit assembly-engaging portion, wherein the second member is configured to selectively engage the second end of the fuel unit assembly-engaging portion.

### Example 5

The fuel unit assembly-lifting adapter of example 1, wherein the elongated fuel unit assembly-engaging portion is configured to alternately engage either a fuel unit or a pallet of the fuel unit assembly.

### Example 6

The fuel unit assembly-lifting adapter of example 5, wherein the fuel unit of the fuel unit assembly is a battery.

### Example 7

The fuel unit assembly-lifting adapter of example 1, wherein each of the first member and the second member of the lift-engaging portion includes a lift engagement structure, wherein each of the lift engagement structures is configured to engage with a respective arm adapter of the vehicle lift.

### Example 8

The fuel unit assembly-lifting adapter of example 7, wherein each of the first member and the second member of the lift-engaging portion further include a sloped transition, wherein the respective sloped transition is configured to elevate the respective lift engagement structure relative to the elongated fuel unit assembly-engaging portion.

### Example 9

The fuel unit assembly-lifting adapter of example 1, wherein the fuel unit assembly-lifting adapter includes a strap configured to span the fuel unit assembly.

### Example 10

The fuel unit assembly-lifting adapter of example 1, wherein the first member includes a hook configured to couple with the first end of the fuel unit assembly-engaging portion.

### Example 11

A method of supporting a fuel unit assembly using a fuel unit assembly-lifting adapter, the fuel unit assembly-lifting adapter including an elongated fuel unit assembly-engaging portion and a lift-engaging portion, the elongated fuel unit assembly-engaging portion being coupled to the lift-engaging portion, the method comprising: extending the elongated fuel unit assembly-engaging portion through a pathway, the pathway being defined by the fuel unit assembly; and engaging a vehicle lift with a first member and a second member to thereby support the fuel unit assembly with the elongated fuel unit assembly-engaging portion.

### Example 12

The method of example 11, the method further comprising defining a respective loop with each of the first member and the second member, the method further comprising looping each loop around a portion of a respective vehicle lift arm of the vehicle lift.

### Example 13

The method of example 11, the method further comprising transitioning the fuel unit assembly between the ground and an elevated support surface using the fuel unit assembly-lifting adapter.

### Example 14

The method of example 11, the fuel unit assembly including an electric vehicle (EV) battery and a pallet, the method further comprising separating the EV battery from the pallet using the fuel unit assembly-lifting adapter.

### Example 15

The method of example 11, wherein the fuel unit assembly-lifting adapter includes a continuous strap, the method further comprising transitioning the fuel unit assembly-lifting adapter through the pathway to thereby engage the vehicle lift at opposing ends of the fuel unit assembly.

### Example 16

The method of example 11, wherein the vehicle lift includes a lift arm and an arm adapter, the arm adapter having an upper portion and a lower portion, the method further comprising: supporting the arm adapter by engaging the upper portion with the lift arm; and supporting the fuel unit assembly by engaging the lower portion with the fuel unit assembly-lifting adapter.

### Example 17

An electric vehicle (EV) battery lifting adapter configured to vertically support an EV battery, the EV battery lifting adapter comprising: an elongated EV battery engaging portion terminating into a first end and a second end; and a lift-engaging portion comprising a first member extending from the first end of the EV battery engaging portion, and a second member extending from the second end of the EV battery engaging portion; wherein the first member and the second member are configured to engage a vehicle lift such that the EV battery engaging portion may raise and lower the EV battery in response to movement of the vehicle lift.

### Example 18

The EV battery lifting adapter of example 17, wherein each of the first member and the second member are integral to the elongated EV battery engaging portion.

### Example 19

The EV battery lifting adapter of example 17, the elongated EV battery engaging portion including a first elongated EV battery engaging portion, the EV battery lifting adapter further comprising a second elongated EV battery engaging portion, wherein each of the first and second elongated EV battery engaging portions are configured to support a respective end of the EV battery.

### Example 20

The EV battery lifting adapter of example 19, wherein each of the first and second elongated EV battery engaging portions are configured to be separated from the other by a gap, wherein the gap is sized to fit a support table.

I/We claim:

1. A fuel unit assembly-lifting adapter configured to couple with a vehicle lift in order to engage, raise, and lower a fuel unit assembly, the fuel unit assembly-lifting adapter comprising:
a) an elongated fuel unit assembly-engaging portion terminating into a first end and a second end and
b) a lift-engaging portion comprising a first member extending from the first end of the fuel unit assembly-engaging portion, and a second member extending from the second end of the fuel unit assembly-engaging portion,
wherein the first member and the second member are configured to detachably engage a vehicle lift such that the fuel unit assembly-engaging portion may raise and lower the fuel unit assembly in response to movement of the vehicle lift.

2. The fuel unit assembly-lifting adapter of claim 1, wherein each of the first and second members include a respective strap defining a loop, wherein the respective strap is configured to engage the vehicle lift.

3. The fuel unit assembly-lifting adapter of claim 2, wherein the loop is configured to loop around a portion of the vehicle lift to thereby couple with the vehicle lift to thus engage, raise, and lower the fuel unit assembly with motion of the portion of the vehicle lift.

4. The fuel unit assembly-lifting adapter of claim 1, wherein the first member is configured to selectively engage the first end of the fuel unit assembly-engaging portion, wherein the second member is configured to selectively engage the second end of the fuel unit assembly-engaging portion.

5. The fuel unit assembly-lifting adapter of claim 1, wherein the elongated fuel unit assembly-engaging portion is configured to alternately engage either a fuel unit or a pallet of the fuel unit assembly.

6. The fuel unit assembly-lifting adapter of claim 5, wherein the fuel unit of the fuel unit assembly is a battery.

7. The fuel unit assembly-lifting adapter of claim 1, wherein each of the first member and the second member of the lift-engaging portion includes a lift engagement structure, wherein each of the lift engagement structures is configured to engage with a respective arm adapter of the vehicle lift.

8. The fuel unit assembly-lifting adapter of claim 7, wherein each of the first member and the second member of the lift-engaging portion further include a sloped transition, wherein the respective sloped transition is configured to elevate the respective lift engagement structure relative to the elongated fuel unit assembly-engaging portion.

9. The fuel unit assembly-lifting adapter of claim 1, wherein the fuel unit assembly-lifting adapter includes a strap configured to span the fuel unit assembly.

10. The fuel unit assembly-lifting adapter of claim 1, wherein the first member includes a hook configured to couple with the first end of the fuel unit assembly-engaging portion.

11. A method of supporting a fuel unit assembly using a fuel unit assembly-lifting adapter, the fuel unit assembly-lifting adapter including an elongated fuel unit assembly-engaging portion and a lift-engaging portion, the elongated fuel unit assembly-engaging portion being coupled to the lift-engaging portion, the method comprising:
a) extending the elongated fuel unit assembly-engaging portion through a pathway, the pathway being defined by the fuel unit assembly; and
b) engaging a vehicle lift with a first member and a second member to thereby support the fuel unit assembly with the elongated fuel unit assembly-engaging portion.

12. The method of claim 11, the method further comprising defining a respective loop with each of the first member and the second member, the method further comprising looping each loop around a portion of a respective vehicle lift arm of the vehicle lift.

13. The method of claim 11, the method further comprising transitioning the fuel unit assembly between the ground and an elevated support surface using the fuel unit assembly-lifting adapter.

14. The method of claim 11, the fuel unit assembly including an electric vehicle (EV) battery and a pallet, the method further comprising separating the EV battery from the pallet using the fuel unit assembly-lifting adapter.

15. The method of claim 11, wherein the fuel unit assembly-lifting adapter includes a continuous strap, the method further comprising transitioning the fuel unit assembly-lifting adapter through the pathway to thereby engage the vehicle lift at opposing ends of the fuel unit assembly.

16. The method of claim 11, wherein the vehicle lift includes a lift arm and an arm adapter, the arm adapter having an upper portion and a lower portion, the method further comprising:
a) supporting the arm adapter by engaging the upper portion with the lift arm; and
b) supporting the fuel unit assembly by engaging the lower portion with the fuel unit assembly-lifting adapter.

17. An electric vehicle (EV) battery lifting adapter configured to vertically support an EV battery, the EV battery lifting adapter comprising:
a) an elongated EV battery engaging portion terminating into a first end and a second end; and
b) a lift-engaging portion comprising a first member extending from the first end of the EV battery engaging portion, and a second member extending from the second end of the EV battery engaging portion;
wherein the first member and the second member are configured to engage a vehicle lift such that the EV battery engaging portion may raise and lower the EV battery in response to movement of the vehicle lift.

18. The EV battery lifting adapter of claim 17, wherein each of the first member and the second member are integral to the elongated EV battery engaging portion.

19. The EV battery lifting adapter of claim 17, the elongated EV battery engaging portion including a first elongated EV battery engaging portion, the EV battery lifting adapter further comprising a second elongated EV battery engaging portion, wherein each of the first and second elongated EV battery engaging portions are configured to support a respective end of the EV battery.

20. The EV battery lifting adapter of claim 19, wherein each of the first and second elongated EV battery engaging portions are configured to be separated from the other by a gap, wherein the gap is sized to fit a support table.
